(19) United States
(12) Patent Application Publication
(10) Pub. No.: US 2024/0362256 A1
(43) Pub. Date: Oct. 31, 2024

(54) METHOD AND SYSTEM FOR PERFORMING HIERARCHICAL CLASSIFICATION OF DATA

(71) Applicant: VETTD, INC., Bellevue, WA (US)

(72) Inventors: Andrew Buhrmann, Redmond, WA (US); Michael Buhrmann, North Bend, WA (US); Dario Salvucci, Elverson, PA (US); Ali Shokoufandeh, New Hope, PA (US)

(73) Assignee: VETTD, INC., Bellevue, WA (US)

(21) Appl. No.: 18/528,993

(22) Filed: Dec. 5, 2023

Related U.S. Application Data
(63) Continuation of application No. 17/085,050, filed on Oct. 30, 2020, now abandoned.
(60) Provisional application No. 62/928,893, filed on Oct. 31, 2019.

(51) Int. Cl. G06F 16/28; G06F 16/35; G06N 3/045

(52) U.S. Cl. CPC G06F 16/285; G06F 16/353; G06N 3/045

(57) ABSTRACT

A method for performing hierarchical classification of data is disclosed. The method is being executed by at least one processing device. The method includes receiving input data for encoding into multiple channels. Further, the method includes extracting one or more features and one or more temporal structures corresponding to the input data. The method further includes identifying one or more feature dependences in the input data. Further, the method includes combining the extracted one or more features corresponding to the input data, the extracted one or more temporal structures of the input data, and the identified one or more feature dependencies in the input data into a combined feature set. Thereafter, the method includes classifying the combined feature set into one or more output classes, and thereby performing the hierarchical classification of data.

### CROSS-REFERENCE TO RELATED APPLICATION

The present application is a continuation of U.S. application Ser. No. 17/085,050, filed Oct. 30, 2020, which claims the benefit of U.S. Provisional Application No. 62/928,893 filed on Oct. 31, 2019, which applications are hereby incorporated by reference as if fully set forth herein.

### FIELD OF THE INVENTION

The invention relates generally to neural taxonomies and auto neural orchestration, and more specifically, relates to a method and system for performing hierarchical classification of data.

### BACKGROUND OF THE INVENTION

A neural network is a series of algorithms that allows recognition of underlying relationships in a set of data through a process that mimics the way the human brain operates. Further, the neural networks are modeled on how the brain processes information to create algorithms to model complex problems for use in pattern recognition and decision-making. Typically, the neural networks help cluster and classify data, recognize an object, and perform cross-modality translations. The creation of the neural network models involves optimizing a statistical model by inputting training data to tune it and enable it to make more accurate predictions; e.g., high accuracy classification of data. Typically, large amounts of data are often required to train the neural network model so that it can process data input into the correct categories.

Currently, one or more techniques for clustering and grouping large data groups has been used to create the neural network models based on large massive training/labeled data being fed in to create a model or multiple separate models. However, such techniques result in large neural(s) that require a significant amount of data to train. Further, such techniques are highly inflexible, difficult to change, and do not deal with intermediate layers of classification. Also, multiple separate models lack coordination between them resulting in additional upfront work to ensure that data is fed to the correct models.

A traditional classification architecture 100 for clustering and grouping large data groups is shown in FIG. 1, according to one prior art. Typically, one or more modalities that correspond to the same set of classes, is shown in FIG. 1. Further, the traditional classification architecture 100 includes a first modality classifier 102, a second modality classifier 104, and common class labels 106. Further, the first modality classifier 102 receives a first input 108 and the second modality classifier 104 receives a second input 110. Further, the traditional classification architecture 100 classifies the first input 108 and the second input 110 into one or more possible outcomes, irrespective of input type (modality) classifiers of the traditional classification architecture 100. For example, consider a music genre classification scenario, the input may be either audio signal(s) i.e. 1^{st} modality and lyrics i.e. 2^{nd} modality. The traditional classification architecture 100 classifies the input into one or more possible genres (Jazz, Blues, etc.), irrespective of input type (modality) classifiers of the traditional classification architecture 100. Such classification problems are very common in pattern recognition with applications, for example, in the case of single modality classification for document classification, two modality audio-video classification, cross-language document labeling, and cross-domain correlation.

Further, existing classifiers in such traditional classification architecture 100, deal with flat classification hierarchies. Typically, such traditional classification architecture 100 fail in dealing with classification under complex taxonomies, in accounting for the inherent context of input data represented in form of correlations in text, and in handling the relative order of the textual information. Thus, the traditional classification architecture 100 lacks in accuracy, speed, and robustness. Therefore, there is a need for an improved method and system for performing hierarchical classification of data.

### SUMMARY OF THE INVENTION

According to embodiments illustrated herein, a method for performing hierarchical classification of data is disclosed. The method includes receiving, by at least one processing device, input data for encoding into multiple channels. Further, the method includes extracting, by the at least one processing device, one or more features corresponding to the input data and one or more temporal structures of the input data. The method further includes identifying, by the at least one processing device, one or more feature dependencies in the input data. Further, the method includes combining, by the at least one processing device, the extracted one or more features corresponding to the input data, the extracted one or more temporal structures of the input data, and the identified one or more feature dependencies in the input data into a combined feature set by the at least one processing device. Further, the method includes classifying by the at least one processing device, the combined feature set into one or more output classes by the at least one processing device, and thereby performing the hierarchical classification of data.

According to embodiments illustrated herein, a system for performing hierarchical classification of data is disclosed. The system includes a memory and at least one processing device coupled to the memory. The at least one processing device is configured to receive input data for encoding into multiple channels. Further, the at least one processing device to extract one or more feature corresponding to the input data, and one or more temporal structures of the input data. Further, the at least one processing device is configured to identify one or more feature dependencies in the input data. Further, the at least one processing device is configured to combine the extracted one or more features corresponding to the input data, the extracted one or more temporal structures of the input data, and the identified one or more feature dependencies in the input data, into a combined feature set. The at least one processing device is further configured to classify the combined feature set into one or more output classes, and thereby perform the hierarchical classification of data.

According to embodiments illustrated herein, a non-transitory computer-readable medium for storing instructions is disclosed. The instructions are executed by at least one processing device which is configured to receive input data for encoding into multiple channels. The at least one processing device is configured to extract one or more feature corresponding to the input data, and one or more temporal structures of the input data. Further, the at least one processing device is configured to identify one or more feature dependencies in the input data. The at least one processing device is further configured to combine the extracted one or more features corresponding to the input data, the extracted one or more temporal structures of the input data, and the identified one or more feature dependencies in the input data, into a combined feature set. Thereafter, the at least one processing device is configured to classify the combined feature set into one or more output classes, and thereby perform the hierarchical classification of data.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale.

Various embodiments will hereinafter be described in accordance with the appended drawings, which are provided to illustrate and not to limit the scope in any manner, wherein similar designations denote similar elements, and in which:

FIG. 1 illustrates a traditional classification architecture 100, in accordance with one prior art;

FIG. 2 illustrates a system 200 for performing hierarchical classification of data, m accordance with at least one embodiment;

FIG. 3 illustrates a block diagram 300 of neural taxonomy and neural orchestration model for performing hierarchical classification of data, in accordance with at least one embodiment;

FIG. 4 illustrates a basic architecture 400 of taxonomy classifiers, in accordance with at least one embodiment;

FIG. 5 illustrates a block diagram of a multimodal taxonomy architecture 500 for multiclass classification, in accordance with at least one embodiment;

FIG. 6A illustrates a project window 600 showing a process of the multimodal taxonomy architecture 500, in accordance with at least one embodiment;

FIG. 6B illustrates a design taxonomy 602 showing a process of the multimodal taxonomy architecture 500, in accordance with at least one embodiment;

FIG. 6C illustrates import documents 604 showing a process of the multimodal taxonomy architecture 500, in accordance with at least one embodiment;

FIG. 6D illustrates process documents 606 of the process of the multimodal taxonomy architecture 500, in accordance with at least one embodiment;

FIG. 6E illustrates manage neurals 610 of the process of the multimodal taxonomy architecture 500, in accordance with at least one embodiment;

FIG. 6F illustrates test neurals 612 of the process of the multimodal taxonomy architecture 500, in accordance with at least one embodiment;

FIG. 6G illustrates a graphical representation 614 of test results, in accordance with at least one embodiment; and

FIG. 7 illustrates a flowchart 700 showing a method for performing hierarchical classification of data, in accordance with at least one embodiment.

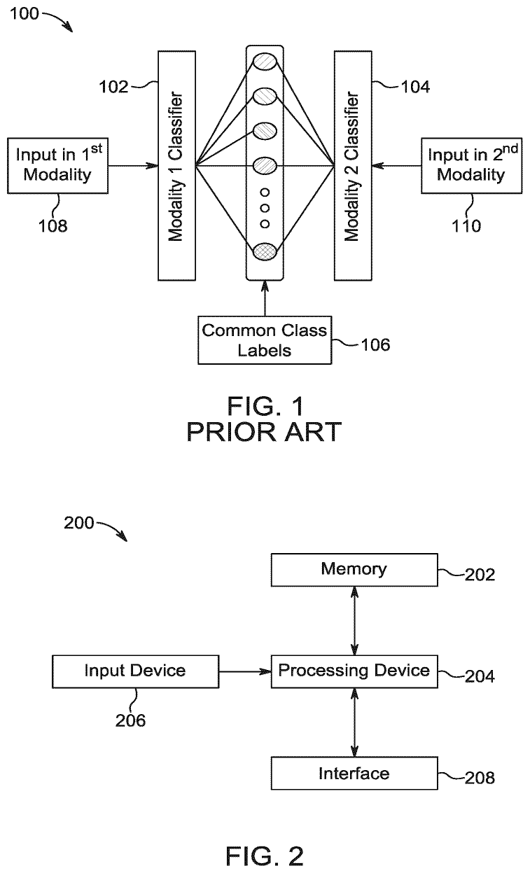

### DETAILED DESCRIPTION OF THE PREFERRED EMBODIMENT

Some embodiments of this disclosure, illustrating all its features, will now be discussed in detail. The words “comprising,” “having,” “containing,” and “including,” and other forms thereof, are intended to be equivalent in meaning and be open-ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context dictates otherwise. Although any systems and methods similar or equivalent to those described herein can be used in the practice or testing of embodiments of the present disclosure, the preferred, systems and methods are now described.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

FIG. 2 illustrates a system 200 of neural taxonomy and neural orchestration for hierarchical classification of data, in accordance with at least one embodiment. The system 200 includes a memory 202, at least one processing device 204, an input device 206, and an interface(s) 208 without departing from the scope of the disclosure.

The memory 202 stores a set of instructions and data. Further, the memory 202 includes the one or more instructions that are executable by the at least one processing device 204 to perform specific operations. It is apparent to a person with ordinary skill in the art that the one or more instructions stored in the memory 202 enable the system 200 to perform the predetermined operations. Some of the commonly known memory implementations include, but are not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other types of media/machine-readable medium suitable for storing electronic instructions.

The at least one processing device 204 may be coupled to the memory 202 and may include suitable logic, circuitry, and/or interfaces that are operable to execute one or more instructions stored in the memory 202 to perform predetermined operations. The at least one processing device 204 may execute an algorithm stored in the memory 202 for neural taxonomy and neural orchestration. In one embodiment, the at least one processing device 204 may be configured to decode and execute any instructions received from one or more other electronic devices or server(s). The at least one processing device 204 may be configured to execute one or more computer-readable program instructions, such as program instructions to carry out any of the functions described in this description. Further, the at least one processing device 204 may be implemented using one or more processor technologies known in the art. Examples of the at least one processing device 204 include, but are not limited to, one or more general-purpose processors (e.g., INTEL® or Advanced Micro Devices® (AMD) microprocessors) and/or one or more special-purpose processors (e.g., digital signal processors or Xilinx® System On Chip (SOC) Field Programmable Gate Array (FPGA) processor).

The input device 206 may comprise suitable logic, circuitry, interfaces, and/or code that may be operable to receive an input from a user. The input may correspond to at least one user preference that includes a selection of one or mode modalities The input data may comprise one or more modalities and the one or more modalities may correspond to an input type. Further, the input device 206 may be operable to communicate with the at least one processing device 204. Examples of the input device may include but are not limited to, a touch screen, a keyboard, and a microphone.

The interface(s) 208 may be coupled to the at least one processing device 204 and may either accept input from the user or provide an output to the user, or may perform both the actions. The interface(s) may either be a Command Line Interface (CLI), Graphical User Interface (GUI), or a voice interface.

In an exemplary embodiment, the system 200 may also include a display device (not shown) to display the classified data to a user. The display device may comprise suitable logic, circuitry, interfaces, and/or code that may be operable to render a graphical user interface. In an embodiment, the display device may display and enable the user to set the at least one user preference. The at least one user preference may include a selection of one or more modalities. In an embodiment, the display device may be a touch screen that enables the user to set the at least one preference. In an embodiment, the touch screen may correspond to at least one of a resistive touch screen, capacitive touch screen, or a thermal touch screen.

It will be apparent to one skilled in the art that the above-mentioned system components of the system 200 have been provided only for illustration purposes. The system 200 may include some other components as well, without departing from the scope of the disclosure.

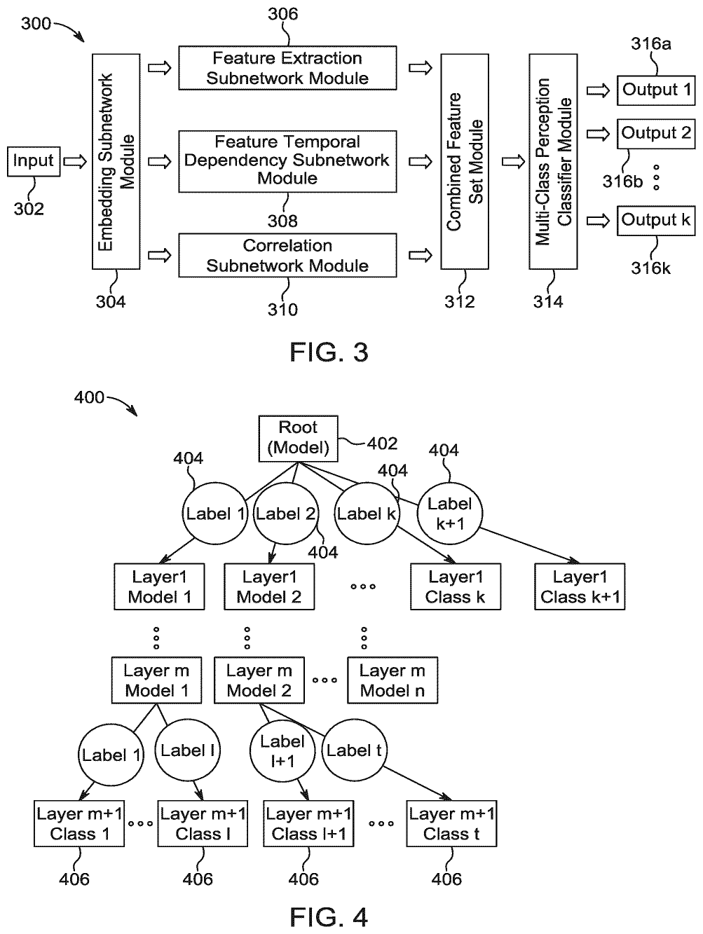

The operation of the system 200 has been described in conjunction with FIGS. 3 and 4. FIG. 3 illustrates a block diagram 300 of neural taxonomy and neural orchestration model for performing hierarchical classification of data, in accordance with at least one embodiment. The neural taxonomy and neural orchestration model includes an input block 302, an embedding subnetwork module 304, a feature extraction subnetwork module 306, a feature temporal dependency subnetwork module 308, a correlation subnetwork module 310, a combined feature set module 312, a multi-class perception classifier module 314, and one or more output blocks 316.

In one embodiment, the at least one processing device 204 may be interfaced with the neural taxonomy and neural orchestration model for hierarchical classification of the data. It should be noted that the at least one processing device 204 may be interfaced with the embedding subnetwork module 304, the feature extraction subnetwork module 306, the feature temporal dependency subnetwork module 308, the correlation subnetwork module 310, the combined feature set module 312, and the multi-class perception classifier module 314.

At first, input data may be received from the input block 302. Further, the input data may be fed to the embedding subnetwork module 304. The embedding subnetwork module 304 may be configured to encode the input data into multiple channels. In one embodiment, by way of non-limiting example, the input data may be resumes, song lyrics, movie screenplays, poems, articles, or product descriptions. Successively, the feature extraction subnetwork module 306 may be configured to extract one or more features corresponding to the input data. In one embodiment, the one or more features may comprise at least one of job skills or educational qualification. Further, the feature temporal dependency subnetwork module 308 may be configured to extract one or more temporal structures of the input data. Further, the correlation subnetwork module 308 may be configured to identify one or more feature dependencies in the input data.

Successively, the feature extraction subnetwork module 306, the feature temporal dependency subnetwork module 308, and the correlation subnetwork module 310 may be coupled to the combined feature set module 312. The combined feature set module 312 may be configured to combine the extracted one or more features corresponding to the input data, the extracted one or more temporal structures of the input data, and identified one or more feature dependencies of the input data. Thereafter, a multi-class perception classifier module 314 coupled to the combined feature set module 312, may be configured to classify the combined feature set into the one or more output classes 316a, 316b, . . . 316k. It should be noted that the classification may be performed using a multilevel classifier. In one embodiment, the multilevel classifier may be a hierarchical multilevel network of interconnected deep neural network models. Further, the multilevel classifier may be configured to facilitate taxonomy classification associated with the one or more modalities.

It should be noted that the neural taxonomy ad neural orchestration model may be a deep neural network model that may require labeled training data and the three subchannels i.e. the feature subnetwork, the feature temporal dependency subnetwork and the correlation subnetwork embedded in the feature extraction subnetwork module 306, the feature temporal dependency subnetwork module 308, and the correlation subnetwork module 310, respectively. Additionally, the three subchannels may be implemented using a convolutional deep network. In one embodiment, the system 200 may be extended with additional subnetworks that may extract other aspects of the input data. In one case, the system 200 may include, pertained subnetworks or residual subnetworks (not shown) that can be added to correct possible corrections to classification processes, without departing from the scope of the disclosure.

FIG. 4 illustrates a basic architecture 400 of the taxonomy classifier, in accordance with at least one embodiment. The taxonomy classifier includes a root 402 having one or more model nodes 404 and one or more terminal class nodes 406. In one embodiment, the taxonomy classifier may be a multilevel classifier. The multilevel classifier may be a hierarchical multilevel network of interconnected deep neural network models of the taxonomy classifier. Further, the interconnected deep neural network models may include a plurality of nodes. In one case, each of the plurality of nodes may be a deep artificial intelligence (AI) model that may make limited local decisions. In another case, each of the plurality of nodes may be a terminal node representing a class label.

Further, as illustrated in FIG. 4, the multilevel classifier may classify data of hierarchical nature that involve multiple decision points and may be trained independently with training data associated with the one or more output classes. Further, the classification of the data may begin from the root 402 and continues through the one or more model nodes 404 until reaching the one or more terminal class nodes 406. Additionally, the classification of the data in the multilevel classifier may be achieved using one or more layers for hierarchical classification of the data.

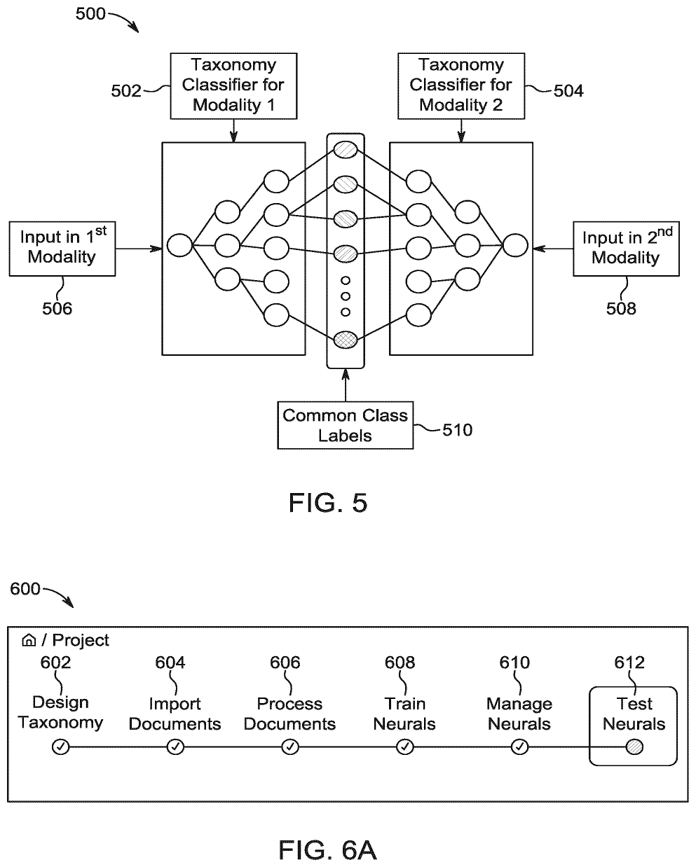

FIG. 5 illustrates a block diagram of a multimodal taxonomy architecture 500 for multiclass classification, in accordance with at least one embodiment. The multimodal taxonomy architecture 500 includes a taxonomy classifier for 1^{st} modality 502, a taxonomy classifier for 2^{nd} modality 504, an input in 1^{st} modality 506, an input in 2^{nd} modality 508, and a common class label 510. It should be noted that the generalization of taxonomy classification may be extended for tasks involving multiple modalities.

For example, in case of classification of resumes for a job role, multiple modalities may be created. The multiple modalities may include input in 1^{st} modality 506 such as texts describing role or job descriptions and input in 2^{nd} modality representing the entity texts. The multimodal taxonomy architecture 500 may include two taxonomy classifiers for two modalities i.e. the taxonomy classifier for 1^{st} modality 502 and the taxonomy classifier for 2^{nd} modality 504. Further, each of the two taxonomy classifiers may be responsible for classifying the entity documents associated with one of the two modalities. Further, the taxonomy classifier for 1^{st} modality 502 and the taxonomy classifier for 2^{nd} modality 504 may be trained by a first input data, i.e. the input in 1^{st} modality 506 and a second input data, i.e. the input in 2^{nd} modality 508, respectively. Further, the taxonomy classifier for 1^{st} modality 502 and the taxonomy classifier for 2^{nd} modality 504 may be coupled to a common class label 510 to store the common classified data of the taxonomy classifier for 1^{st} modality 502 and the taxonomy classifier for 2^{nd} modality 504.

It should be noted that the first input data and the second input data may be completely different and the two taxonomy classifiers i.e. the taxonomy classifier for 1^{st} modality 502 and the taxonomy classifier for 2^{nd} modality 504 may be trained through different training processes. It should be noted that the structure of the taxonomy classifier for 1^{st} modality 502 and the taxonomy classifier for 2^{nd} modality 504 may be same such as, but not limiting to, same architecture, same number of location of models, same number, and location of terminal nodes. It will be apparent to one skilled in the art that the multimodal taxonomy architecture 500 of the neural taxonomy and neural orchestration model 300 may include more than two taxonomy classifiers for more than two modalities, without departing from the scope of the disclosure.

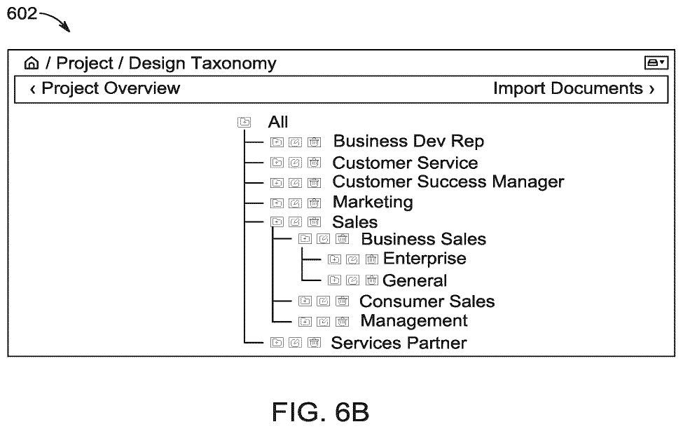

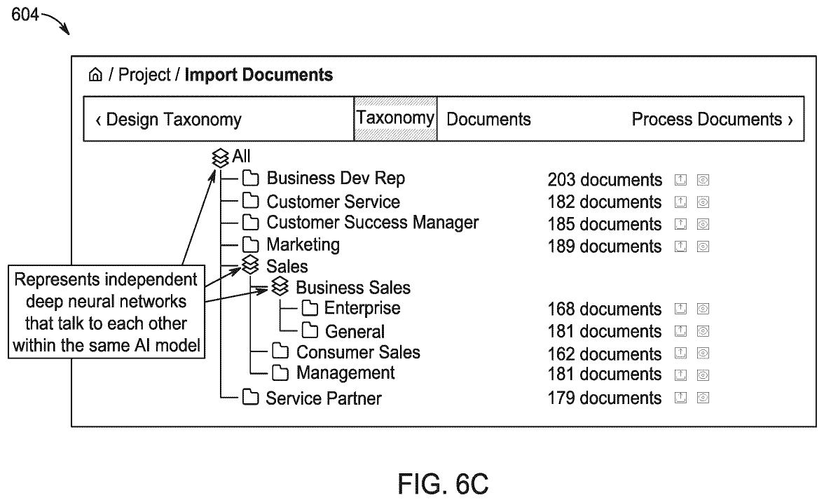

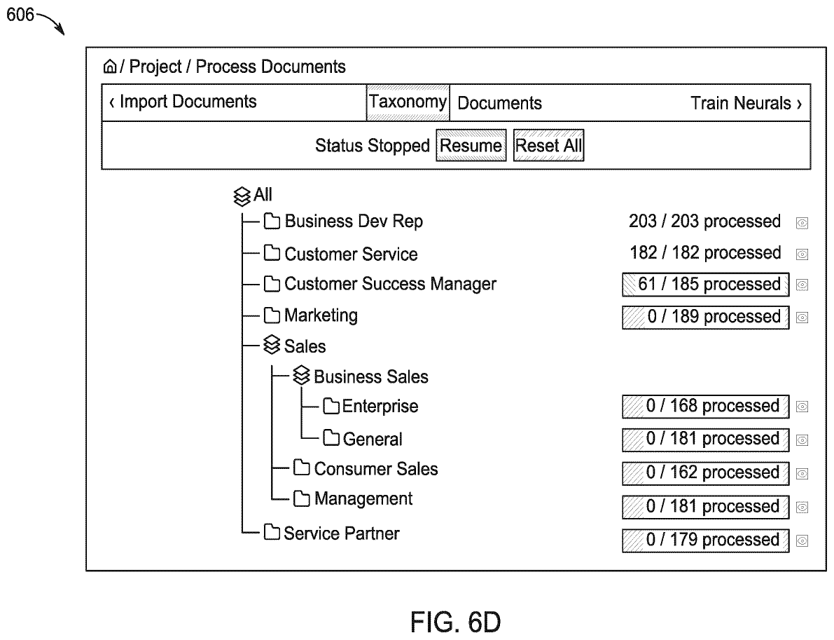

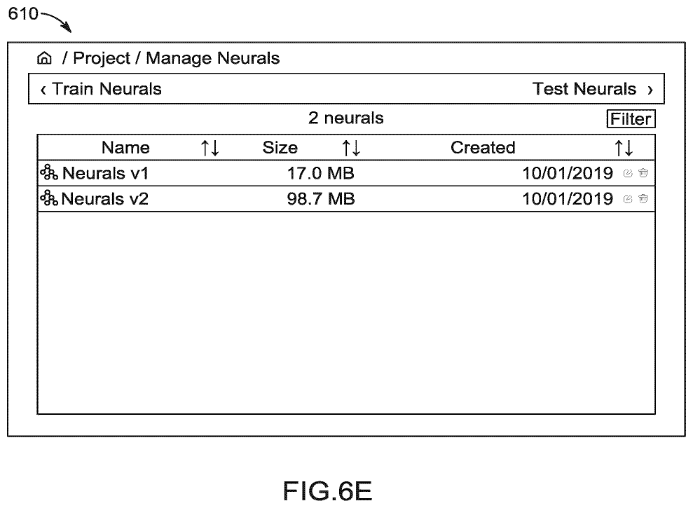

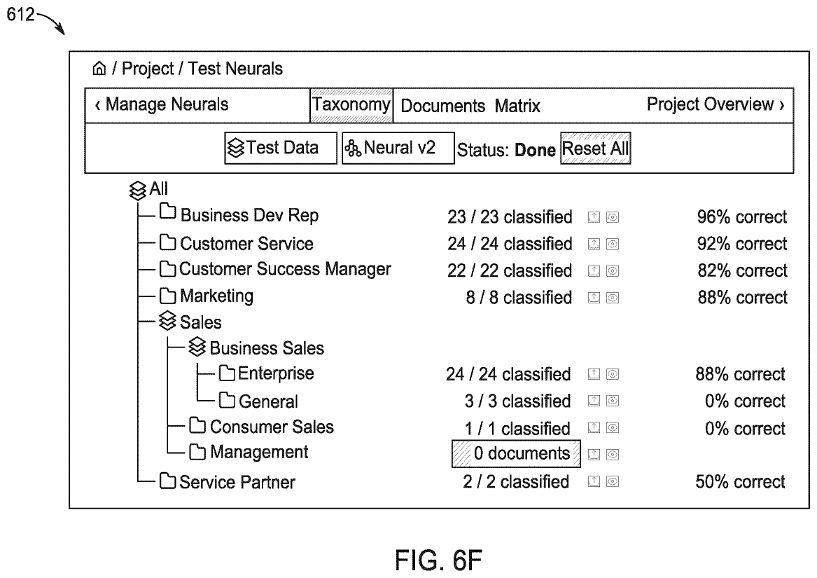

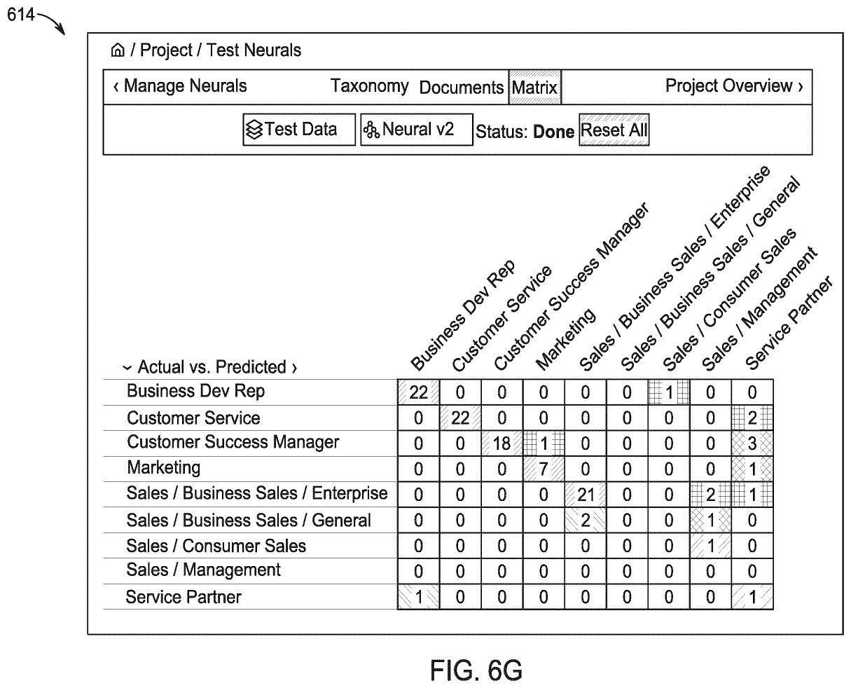

FIG. 6A is a project window 600 showing a process of generating the multimodal taxonomy 400, in accordance with at least one embodiment. The project window 600 illustrates a process to design a taxonomy, from designing to training, and testing the neural network within the same AI model. The project window 600 may include design taxonomy 602, import documents 604, process documents 606, train neurals 608, manage neurals 610, and test neurals 612. The project window 600 is described in conjunction with FIGS. 6B, 6C, 6D, 6E, 6F, and 6G.

At first, in the design taxonomy 602, the taxonomy model may be designed, as shown in FIG. 6B. It should be noted that a top layer of the taxonomy has to be a first deep neural network model for classification point, labeled “All.” Further, a number of classification decisions may be based on how narrow the user of the AI model wants to classify the data (into subcategories). In one case, the user may want to have one classification on sales and break up sales into several different subcategory classifications based on experience that shows whether the data represents an individual with general sales experience or sales experience to business customers, to consumers, or represents someone with sales management experience. This will be achieved through allocating a second deep neural network model for classification point of subcategories.

Successively, in imports document 604, the taxonomy model may import training documents, as shown in FIG. 6C. The designed taxonomy may be shown with the deep neural networks created to pass the data to the correct classification folders for training of models at all classification points. Further, the documents represent the sources used to train the model at each classification. Successively, the taxonomy model may process the imported documents in process documents 606, as shown in FIG. 6D. In this case, the appointment of documents to classification points will be automated by classification system. Further, the taxonomy model may utilize the processed documents to prepare the furnished documents in training of all classification point neurals 608. Successively, the taxonomy model may manage all trained neurals pretraining to the same taxonomy in the manage neurals 610, as shown in FIG. 6E. Thereafter, the taxonomy model may test the managed neural network in the test neurals 612 against known data and outcomes may be examined to determine accuracy of the taxonomy trained models. In one case, the tested data indicating number of documents correctly classified by the taxonomy model, as illustrated in FIG. 6F. In another case, the tested data indicating number of documents correctly classified by one of the trained neural models associated with the designed taxonomy may be represented graphically 614, as shown in FIG. 6G.

It will be apparent to one skilled in the art that the above-mentioned method for performing hierarchical classification of data have been provided only for illustration purposes, without departing from the scope of the disclosure.

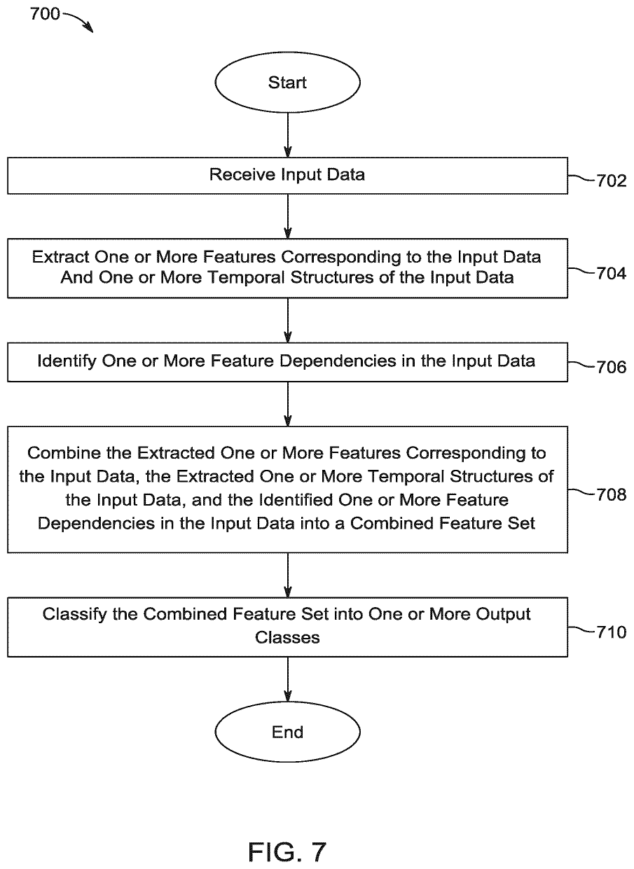

FIG. 7 is a flowchart illustrating a method 700 for performing hierarchical classification of data, in accordance with at least one embodiment. The flowchart 700 is described in conjunction with FIGS. 2, 3, 4, 5, and 6A-6G.

At first, the at least one processing device 204 may receive input data for encoding into multiple channels, at step 702. In one case, the input data may be resumes, songs, movies, poems, articles, products descriptions, etc. Successively, the at least one processing device 204 may extract one or more features corresponding to the input data, and one or more temporal structures of the input data, at step 704. Further, the at least one processing device 204 may identify one or more feature dependencies in the input data, at step 706. Upon extracting the one or more features, one or more input temporal structures of the input data and identifying one or more features dependencies in the input data, the at least one processing device 204 may combine the extracted one or more features corresponding to the input data, the extracted one or more temporal structures of the input data, and the identified one or more feature dependencies in the input data into a combined feature set, at step 708. Thereafter, the at least one processing device 204 may classify the combined feature set into one or more output classes, at step 710. In one case, the combined feature set may be classified into one or more output classes by a multilevel classifier that may be trained with training data associated with the one or more output classes. In one embodiment, the multilevel classifier may be a hierarchical multilevel network of interconnected deep neural network models. Thus, such method may be used for performing hierarchical classification of data.

The disclosed embodiments encompass numerous advantages. Various embodiments of system and method for performing hierarchical classification of data have been disclosed. The disclosed method utilizes hierarchical classification of data and therefore eliminates common classification problems such as single modality classification for document classification, two modality audio-video classification, cross-language document labeling, and cross-domain correlation. Further, the disclosed method uses a truly hierarchical structures approach where a neural model for making decisions is trained and utilized at each class or subclass which are also decision points; allowing for specialized and focused decision-making. Such type of disclosed method and system results in less data requirement for training, allows models to deal with finer and finer classes, allows for the creation of models with more complex decision categories and decision points, and provides the ability to change decision points dynamically Further, use of less data for training also reduces privacy risks associated with collecting, sharing, and retaining large amounts of data which may include personal information. Such type of disclosed method and system provides an improved way of classifying and managing data using a neural taxonomy and neural orchestration. Further, such invention eliminates the issue of hierarchical classification of large data groups by creating a user-designed friendly approach to quickly create multiple levels of classes that may be readily expanded or contracted. Thus, such type of method and system provides improved and accurate hierarchical classification of data.

The disclosed method discloses a hierarchical approach to create many models. Further, a metadata substructure, capturing the dependency between models, classes, subclasses and terminal classes of the hierarchy, ties all these models together. Further, the metadata provides necessary information for performing the actual classification using an orchestration environment capable of executing the complex decision support systems (called the Vettd Intelligent Neural Orchestration or “VINO”) to make a single or multi-model approach work. The orchestration environment in the disclosed invention is flexible; and classification, and sub-classification layers may be expanded or shrunk as per the requirements. The orchestration environment further manages and maintains the relationships between the models (discussed above) regardless of the number of classification layers involved and ensures the right model(s) is invoked as data is fed into the system during execution (classification).

Further, the disclosed method utilizes subnetworks for hierarchical classification of data and thus provides solution for complex taxonomies for inherent context of input data represented in from of correlations in text, and in handling the relative order of the textual information. Therefore, the disclosed method and system are more accurate, fast, robust, and require less time for training and performing classifications.

The features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope.

Features that are described and/or illustrated with respect to one embodiment may be used in the same way or in a similar way in one or more other embodiments and/or in combination with or instead of the features of the other embodiments.

While the preferred embodiment of the present invention has been illustrated and described, as noted above, many changes can be made without departing from the spirit and scope of the invention. For example, aspects of the present invention may be adopted on alternative operating systems. Accordingly, the scope of the invention is not limited by the disclosure of the preferred embodiment. Instead, the invention should be determined entirely by reference to the claims that follow.

What is claimed is:

1. A method for performing hierarchical classification of data, the method comprising:
receiving, by at least one processing device, input data;
encoding the input data into multiple channels comprising a convolutional deep neural network;
extracting, by the at least one processing device, one or more features corresponding to the encoded input data;
extracting, by the at least one processing device, one or more temporal structures of the encoded input data;
identifying, by the at least one processing device, one or more feature dependencies in the input data, wherein the extracting steps and identifying step are performed by the convolutional deep neural network;
combining, by the at least one processing device, the extracted one or more features corresponding to the encoded input data, the extracted one or more temporal structures of the encoded input data, and the identified one or more feature dependencies in the input data, into a combined feature set; and
classifying, by the at least one processing device, the combined feature set into one or more output classes, and thereby performing the hierarchical classification of data wherein classifying the combined feature set into the one or more output classes is performed using a classifier comprising a plurality of nodes, each said node comprising a neural network.

2. The method of claim 1, wherein classifying the combined feature set into the one or more output classes is performed using a multilevel classifier.

3. The method of claim 2, wherein the multilevel classifier is a hierarchical multilevel network of interconnected deep neural network models.

4. The method of claim 2, wherein the multilevel classifier is trained with training data associated with the one or more output classes.

5. The method of claim 1, wherein the input data is in the form of one or more modalities, the one or more modalities correspond to an input type.

6. The method of claim 2, wherein the multilevel classifier is configured to facilitate taxonomy classification associated with the one or more modalities.

7. The method of claim 1, wherein the input data comprises at least one of candidate profiles, resumes, songs, or movies.

8. The method of claim 1, wherein the one or more features comprises at least one of job skills or educational qualification.

9. A system for performing hierarchical classification of data, the system comprising:
a memory; and
at least one processing device coupled to the memory, the at least one processing device is configured to:
receive input data;
encode the input data into multiple channels comprising a convolutional deep neural network;
extract one or more feature corresponding to the input data;
extract one or more temporal structures of the encoded input data;
identify one or more feature dependencies in the encoded input data, wherein the extracting and identifying are performed by the convolutional deep neural network;
combine the extracted one or more features corresponding to the input data, the extracted one or more temporal structures of the encoded input data, and the identified one or more feature dependencies in the encoded input data, into a combined feature set; and
classify the combined feature set into one or more output classes using a classifier comprising a plurality of nodes, each said node comprising a neural network, and thereby perform the hierarchical classification of data.

10. The system of claim 9, wherein the at least one processing device is configured to classify the combined features set into the one or more output classes, using a multilevel classifier.

11. The system of claim 10, wherein the multilevel classifier is a hierarchical multilevel network of interconnected deep neural network models.

12. The system of claim 10, wherein the multilevel classifier is trained with training data associated with the one or more output classes.

13. The system of claim 10, wherein the input data is in the form of one or more modalities, the one or more modalities correspond to an input type.

14. The system of claim 10, wherein the multilevel classifier is configured to facilitate taxonomy classification associated with the one or more modalities.

15. The system of claim 9, wherein the input data comprises at least one of candidate profiles, resumes, songs, or movies.

16. The system of claim 9, wherein the one or more features comprises at least one of job skills or educational qualification.

17. The system of claim 9, wherein the at least one processing device is configured to classify the data until a terminal class node is reached.

18. A non-transitory computer-readable medium for storing instructions, wherein the instructions are executed by at least one processing device, wherein the at least one processing device is configured to:
receive input data;
encoding the input data into multiple channels comprising a convolutional deep neural network;
extract one or more feature corresponding to the encoded input data;
extract one or more temporal structures of the encoded input data;
identify one or more feature dependencies in the encoded input data, wherein the extracting and identifying are performed by a convolutional deep network;
combine the extracted one or more features corresponding to the input data, the extracted one or more temporal structures of the encoded input data, and the identified one or more feature dependencies in the encoded input data, into a combined feature set; and
classify the combined feature set into one or more output classes using a classifier comprising a plurality of node, each said node comprising a neural network, and thereby perform the hierarchical classification of data.

19. The non-transitory computer-readable medium according to claim 18, wherein classifying the combined feature set into the one or more output classes, using a multilevel classifier.

20. The non-transitory computer-readable medium according to claim 18, wherein the multilevel classifier is a hierarchical multilevel network of interconnected deep neural network models and the multilevel classifier is trained with training data associated with the one or more output classes.
